(19) United States
(12) Patent Application Publication
(10) Pub. No.: US 2008/0148075 A1
(43) Pub. Date: Jun. 19, 2008

(54) Method and system of controlling power states of devices

(75) Inventor: John R. Reder, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/639,978

(22) Filed: Dec. 15, 2006

(51) Int. Cl. G06F 1/00

(52) U.S. Cl. 713/300

(57) ABSTRACT

In a method embodiment, a method for controlling power includes receiving a user input to control the on/off state of one or more electronic devices plugged into a plurality of respective power sockets in a power strip. The method further includes determining, by the power strip, an electrical characteristic of respective ones of the plurality of power sockets. Additionally, the method includes toggling the on/off state of the one or more of the plugged in electronic devices based on the determination.

### TECHNICAL FIELD

This invention relates in general to controlling power to electronic devices and, in particular, to synchronizing power states of multiple electronic devices.

### OVERVIEW

Electronic systems often include multiple interconnected devices that may each independently turn on and off. Home entertainment systems commonly include such interconnected devices. In addition to manual toggle switches, devices of such systems are often operable to receive remote transmissions toggling respective on/off power states. Some programmable remote controls, or universal remotes, may provide remote transmissions to a variety of different devices from a variety of manufacturers. However, efficiently synchronizing the on/off power states of the interconnected devices, which may each have independently controlled on/off toggle functionality, is limited for a variety of reasons.

### SUMMARY OF THE EXAMPLE EMBODIMENTS

In a method embodiment, a method for controlling power includes receiving a user input to control the on/off state of one or more electronic devices plugged into a plurality of respective power sockets in a power strip. The method further includes determining, by the power strip, an electrical characteristic of respective ones of the plurality of power sockets. Additionally, the method includes toggling the on/off state of the one or more of the plugged in electronic devices based on the determination.

In one embodiment, a power control system includes a power strip having a plurality of power sockets, a plurality of sensors, a receiver, a transmitter, and one or more processors. Each sensor is responsive to an electrical characteristic of respective ones of the plurality of power sockets. The receiver is operable to receive a remote input. The one or more processors are in communication with the receiver and one or more of the one or more sensors. In addition, each processor is operable to receive the remote input from the receiver and, in response, interpret one or more of the electrical characteristics and communicate the interpretation to a transmitter.

Technical advantages of some embodiments of the disclosure may include an enhanced intelligent synchronization of the on/off power states for the devices of an electrical system. In some embodiments, a universal remote control in communication with a universal power strip at least partially effects the intelligent synchronization. Various embodiments may further include communication having authentication keys that guarantee the use of specific brands of electronics.

It will be understood that the various embodiments of the disclosure may include some, all, or none of the enumerated technical advantages. In addition other technical advantages of the disclosure may be readily apparent to one skilled in the art from the figures, description, and claims included herein.

### BRIEF DESCRIPTION OF THE DRAWINGS

For a more complete understanding of the disclosure and features and advantages thereof, reference is now made to the following description, taken in conjunction with the accompanying drawings, in which:

FIG. 1 is a block diagram of a portion of an electronic system having a plurality of devices plugged into a power socket and at least partially controlled by a controller in accordance with a particular embodiment of the present invention;

FIG. 2 is a process illustrating acts related to mapping the plugged in devices to respective power sockets of FIG. 1; and

FIG. 3 is a process illustrating acts related to synchronizing the on/off power states of the devices of FIG. 1.

### DESCRIPTION OF EXAMPLE EMBODIMENTS

In accordance with the teachings of the present disclosure, a power control system and a method for the same are provided. By utilizing a programmable remote control operable to communicate with a power strip and a plurality of interconnected devices plugged into the power strip, particular embodiments of the present disclosure may intelligently synchronize the power states of the devices in accordance with a user request.

Particular examples and dimensions specified throughout this document are intended for example purposes only, and are not intended to limit the scope of the present disclosure. In particular, this document is not intended to be limited to an electronic system, such as, an Audio/Visual system.

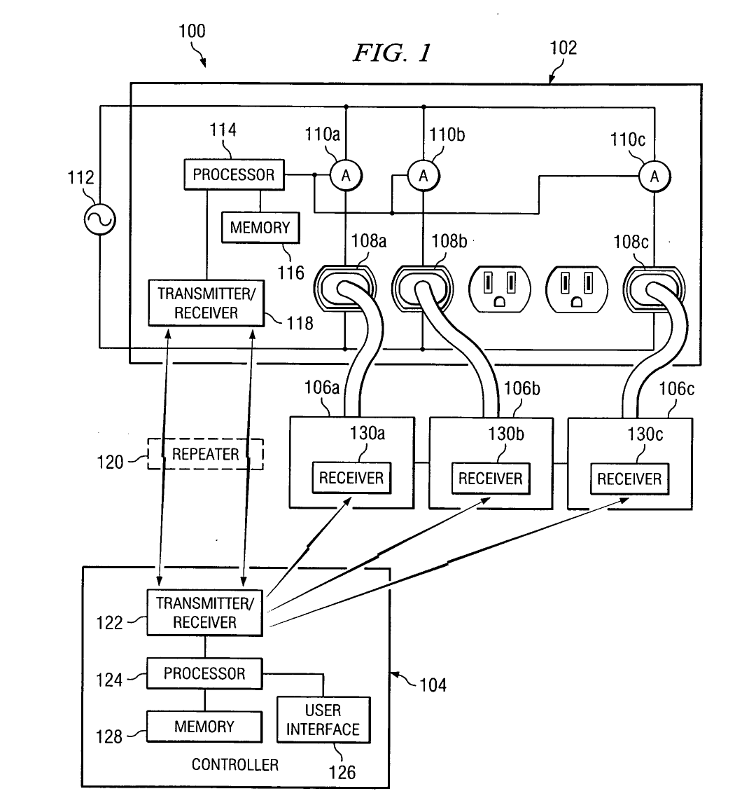

FIG. 1 is a block diagram of a portion of an electronic system 100 in accordance with a particular embodiment of the present invention. As shown in FIG. 1, electronic system 100 generally includes a power strip 102, a controller 104, and a plurality of devices 106a, 106b, and 106c plugged into the power strip 102. As explained further below, in various embodiments, control module 104 may receive information from power strip 102 regarding the power states of the devices 106 and, based at least partly on the received information, toggle specific ones of the power states to accommodate a user request.

In the example embodiment, power strip 102 generally couples devices 106 to a power source 112 and facilitates the control of power states for devices 106. Power strip 102 includes an array of power sockets or outlet receptacles 108, each electrically coupled to power source 112 and each operable to receive a plug. One or more sensors 110 generally detect an electrical characteristic of a respective power socket 108. In this particular embodiment, sensors 110 are each a current-sensing resistor disposed in series to a respective power socket 108; however, other types of sensors and configurations may be used to detect any of a variety of electrical characteristics. In the example embodiment, each sensor 110 couples to control circuitry (not explicitly shown) for determining the amount of current drawn by devices 106 through respective power sockets 108 and for communicating the determination to a processor 114.

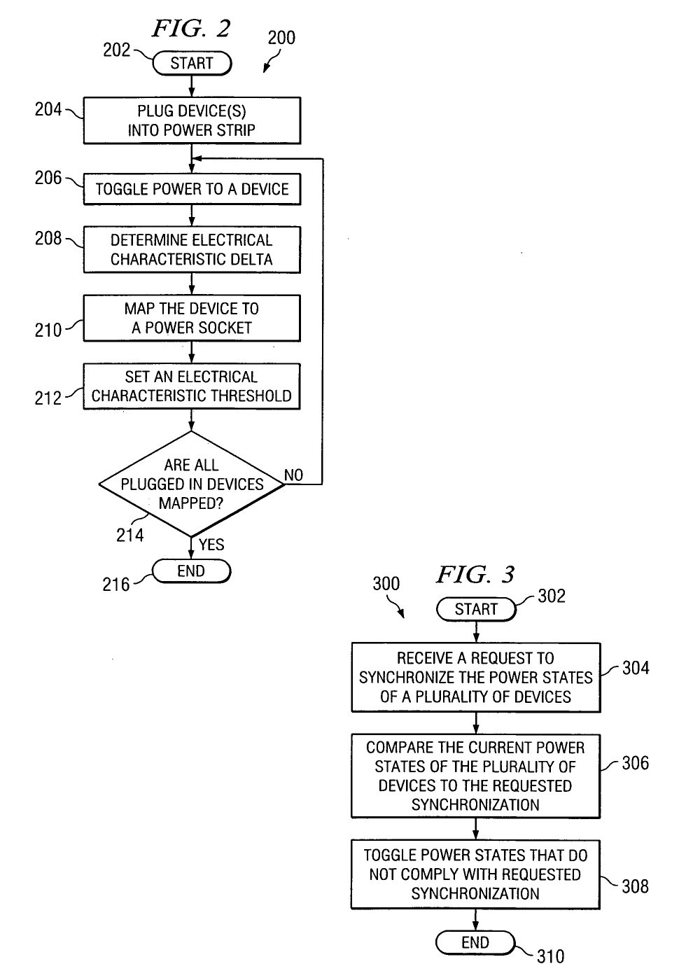

In the example embodiment, processor 114 in power strip 102 is generally operable to interpret whether the current quantification, provided by sensors 110 and associated control circuitry, indicate an on state or an off state for each plugged in device 106. As explained further with reference to FIGS. 2 and 3, the interpretation may include comparing the provided current levels to information stored in memory 116. Power strip 102 is operable to communicate the interpretation to controller 104.

The communication between power strip 102 and controller 104 may be effected by any of a variety of processes. In the example embodiment, power strip 102 includes a transmitter/receiver 118 in communication with processor 114 and operable to communicate with a transmitter/receiver 122 of controller 104. The communication between transmitters/receivers 118 and 122 may be effected, for example, by wireless technology such as Bluetooth, infrared, or radio waves. The data communicated between transmitters/receivers 118 and 122 may include the on/off states of devices 106, as interpreted by processor 114, and requests for such information by controller 104. In some embodiments, a repeater 120 may facilitate the communication between the transmitters/receivers 118 and 122. Although the example embodiment uses wireless communication, other embodiments may alternatively use hardwired communication between power strip 102 and controller 104.

Controller 104 is generally operable to receive user input, receive communication from power strip 102 regarding the power states of devices 106, and send signals to the devices 106 that already comply with the user input. The signals of controller 104 may toggle the power states of the noncompliant devices 106. In the example embodiment, controller 104 generally includes a processor 124 coupled to transmitter/receiver 122, a user interface 126, and memory 128. As explained further below, user interface 126 is operable to receive user input, including programming instructions that may be stored in memory 128. Processor 124 is generally operable to interpret user input and control transmitter/receiver 122 accordingly.

In the example embodiment, transmitter/receiver 122 is further operable to communicate with the receivers 130 of devices 106; however, in various other embodiments controller 104 may include a separate transmitter or transmitter/receiver dedicated to communication with devices 106. As illustrated in FIG. 1, the communication between transmitter/receiver 122 of controller 104 and receivers 130 of devices 106 may be effected, for example, by wireless technology such as Bluetooth, infrared, or radio waves; however, various other embodiments may use hardwired communication between controller 104 and devices 106.

Devices 106 generally refer to any electronic device operable to receive communication from controller 104 and electrically couple to a respective power socket 108 of power strip 102. In the example embodiment, the devices 106 are interconnected audio/visual equipment. For example, electronic system 100 may include a Digital Video Disc (DVD) player 106b in communication with a stereo system 106c and a television 106a.

Conventional audio/visual devices typically use one control function for power, which toggles power between on and off states. Each control function typically is initiated by a manual button press on the audio/visual device or by receipt of a remote transmission. Although conventional universal remote controls typically are operable to send the appropriate remote transmissions, most universal remote controls have no way of ascertaining the present power state of each audio/visual device. Thus, most universal remote controls cannot positively execute a macro to turn on several audio/visual devices because a toggle instruction sent to a device that is already on will incorrectly turn off the device.

Accordingly, some particular embodiments of the present invention may intelligently synchronize the power states of audio/visual devices 106 of an electronic system 100. In some embodiments, the synchronization may be effected by using a universal remote control 104 that first determines the current power state of devices 106, and then sends on/off toggle transmissions only to those devices 106 with current power states noncompliant with a user inputted macro. In some embodiments, use of a power strip 102 in determining the current power states may improve the universality of the power state synchronization. The electronic system 100 of various embodiments may further include authentication communication to guarantee the use of specific brands of power strips 102, remote controls 104, and devices 106. In such embodiments, the authentication communication between components 102, 104, and 106 may include the exchange of authentication keys via, for example, radio waves, infrared, Bluetooth, wire, and/or power line encoding. Processes associated with these generalized example embodiments are illustrated in FIGS. 2 and 3.

FIG. 2 illustrates acts related to mapping the plugged in devices 106 of FIG. 1 to respective ones of a plurality of power sockets 108 in accordance with a particular embodiment of the present disclosure. The process 200 begins in block 204, after start block 202, by plugging a plurality of devices 106 into a power strip 102. The power state of one of the plurality of devices 106 is toggled in block 206. In block 208, a processor 114 of power strip 102 monitors each of a plurality of sensors 110 and determines which power socket 108 had a change in an electrical characteristic as a result of the power state toggle of block 206. As described previously with reference to FIG. 1, in various embodiments, the electrical characteristic sensed by the sensor 110 may be current drawn by the device 106 through a respective power socket 108.

Processor 114 stores in memory 116 an association between the device 106 and the particular power socket 108 in block 210. In block 212, processor 114 writes to memory 116 an electrical characteristic threshold associated with the power states of the device 106. The threshold is at least partially based on the electrical characteristic delta sensed by the sensor resulting from the toggle of block 206. The threshold is set in block 212 such that the quantified electrical characteristics of the on and off power states of the device 106 are on opposite sides of the threshold. For example, sensing a high to low current change may indicate an on to off transition resulting from the toggle of block 206. In such a case, the threshold set in block 212 may be, for example, a current value midway between the high and low currents sensed by sensors 110 as a result of the toggle of block 206. In block 214, a decision is made regarding whether all the devices 106 have been mapped with set thresholds. If not, process 200 loops back to block 206 and continues with the next device 106. Otherwise, process 200 terminates in block 216.

FIG. 3 illustrates acts related to synchronizing the on/off power states of the devices 106 of FIG. 1 in accordance with a particular embodiment of the present disclosure. After starting in block 302, the process 300 begins by receiving a request to synchronize the on/off power states of devices 106. In various embodiments, a user of controller 104 may input the request by selecting a previously recorded macro. In such embodiments, memory 128 of controller 104 may store a desired on or off state for each device 106 associated with the macro.

In block 306, the present on/off power states of devices 106 are compared to the respective power states of the requested synchronization. As described previously with reference to FIGS. 1 and 2, the present on/off power states may be determined by sensing an electrical characteristic of power sockets 108 previously mapped to respective devices 106. The power states that do not presently comply with the requested synchronization are toggled in block 308. Process 300 then terminates in block 310. Thus, in the illustrated embodiment, process 300 illustrates intelligent, universal control over the on/off power states of devices 106.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A method of controlling power comprising:
receiving a user input to control the on/off state of one or more electronic devices plugged into a plurality of respective power sockets in a power strip;
determining, by the power strip, an electrical characteristic of the respective ones of the plurality of power sockets; and
toggling the on/off state of the one or more of the plugged in electronic devices based on the determination.

2. The method of claim 1, wherein determining an electrical characteristic comprises determining whether current drawn through respective ones of the plurality of power sockets exceeds respective thresholds.

3. The method of claim 2, and further comprising setting the respective thresholds by turning on respective ones of the one or more electronic devices and storing respective current levels corresponding to respective on states of the one or more electronic devices.

4. The method of claim 1, and further comprising:
remotely communicating the user input to the power strip;
remotely communicating, by the power strip, a signal based on the determination of the electrical chrematistic of the respective ones of the plurality of power sockets; and
wherein toggling the on/off state of the one or more of the plugged in electronic devices based on the determination comprises remotely communicating one or more signals to the respective plugged in electronic devices.

5. The method of claim 4, wherein remotely communicating comprises communicating using wireless technology selected from the group consisting of:
blue-tooth;
infrared; and
radio wave.

6. The method of claim 1, and further comprising:
storing a macro that sets the on/off state of the plugged in devices;
wherein receiving user input comprises receiving a request to execute the macro; and
wherein toggling the on/off state of the one or more of the plugged in electronic devices based on the determination further comprises toggling the on/off state according to the macro.

7. The method of claim 1, and further comprising:
mapping each of the plugged in electronic devices to respective ones of the plurality of power sockets by:
selecting each of the plugged in electronic devices by toggling the on/off state one at a time;
sensing a change in the electrical characteristic of respective ones of the plurality of power sockets after each selection; and
storing an association of the selected electronic device with the respective ones of the plurality power sockets.

8. The method of claim 1, wherein receiving a user input further comprises exchanging authentication keys.

9. A power control system comprising:
a power strip comprising:
a plurality of power sockets;
a plurality of sensors each responsive to an electrical characteristic of respective ones of the plurality of power sockets;
a receiver operable to receive a remote input; and
one or more processors, each processor in communication with the receiver and one or more of the one or more sensors, each processor operable to receive the remote input from the receiver and, in response, interpret one or more of the electrical characteristics and communicate the interpretation to a transmitter.

10. The power control system of claim 9, wherein each sensor comprises a current sensor in communication with respective ones of the plurality of power sockets, and control circuitry coupled to each current sensor for determining the current drawn through the respective ones of the plurality of power sockets.

11. The power system of claim 10, wherein each processor is further operable to determine whether the current drawn through the respective ones of the plurality of power sockets is in excess of respectively determined thresholds.

12. The power system of claim 11, wherein each processor is further operable to set the respectively determined thresholds, at least in part, by comparing a high current level and a low current level of the respective ones of the plurality of power sockets.

13. The power control system of claim 9, and further comprising:
a controller comprising:
a user interface operable to receive a user input;
a transmitter operable to transmit, based on the user input, the remote input to the receiver of the power strip;
a receiver operable to receive the interpretations transmitted by the transmitter of the power strip; and
wherein the transmitter is further operable to transmit, based at least partly on the interpretations received from the transmitter of the power strip, one or more power state control signals.

14. The power control system of claim 13, and further comprising one or more devices electrically coupled to respective ones of the plurality of power sockets; and
wherein the one or more power state control signals are operable to control the on/off state of at least a subset of the one or more devices.

15. The power control system of claim 14, wherein the controller is further operable to store a macro indicating the desired on/off states of at least a subset of the one or more devices; and
wherein execution of the macro depends at least in part on the interpretations transmitted by the transmitter of the power strip.

16. The power control system of claim 13, wherein the power strip and the controller are operable to transmit and receive by wireless communication selected from the group consisting of:
blue-tooth;
infrared; and
radio wave.

17. The power control system of claim 13, wherein the power strip and the controller are further operable to transmit and receive authentication codes enabling execution of the user input.

18. The power control system of claim 13, wherein the devices are further operable to transmit and receive authentication codes enabling execution of the control signals.

19. A method of controlling power to electronic devices, comprising:
receiving a user input to control the on/off state of a plurality of electronic devices plugged into a plurality of respective power sockets in a power strip;
mapping each of the plugged in electronic devices to respective ones of the plurality of power sockets;
storing, by the power strip, a respective on-state current threshold associated with each plugged in device;
determining the on/off state of each of the electronic devices by interpreting whether the current levels associated with each plugged in device exceeds the respective on-state current threshold; and
toggling the on/off state of the one or more of the plugged in electronic devices based on the determination.

20. The method of claim 19, wherein toggling the on/of state comprises transmitting wireless communication.
